(19) United States
(12) Patent Application Publication
(10) Pub. No.: US 2025/0301974 A1
(43) Pub. Date: Oct. 2, 2025

(54) Water Holding System

(71) Applicant: Tankless Pty Ltd, Cranbourne Vic (AU)

(72) Inventor: Darren Schmutter, South Yarra Vic (AU)

(21) Appl. No.: 19/085,963

(22) Filed: Mar. 20, 2025

(30) Foreign Application Priority Data
Mar. 21, 2024 (AU) 2024900762
Jun. 14, 2024 (AU) 2024901818

(51) Int. Cl. A01G 25/00; B01D 24/22; B01D 35/157; E03F 1/00

(52) U.S. Cl. CPC A01G 25/003; B01D 24/22; B01D 35/1573; B01D 2101/04; E03F 1/002

(57) ABSTRACT

A water holding system 1 including lining a hole 2 with both a permeable 10 and impermeable 20 to water layer in the form of a film or sheet, the impermeable layer 20 positioned exterior relative to the permeable layer 10 the hole 2 is filled with a water permeable filtration medium 3, wherein the water holding system 1 includes a valve 30 positioned at a base 1a of the water holding system 1 and an access pipe 40 including Agi pipe extending from the valve 30 to ground level 4.

This application is a Convention Application claiming priority from Australian Provisional Patent Application Nos. 2024900762 and 2024901818 respectively filed on 21 Mar. 2024 and 14 Jun. 2024, the entire contents of which are hereby incorporated by reference.

### FIELD OF INVENTION

This invention relates to a hole for a water holding system. More particularly, this invention relates to water holding system including films or sheets set in existing holes.

### BACKGROUND ART

The following references to and descriptions of prior proposals or products are not intended to be, and are not to be construed as, statements or admissions of common general knowledge in the art. In particular, the following prior art discussion should not be assumed to relate to what is commonly or well known by the person skilled in the art, but to assist in the inventive process undertaken by the inventor and in the understanding of the invention.

Old pools or ponds lack filtration if refilled with water. Furthermore, filtration setups often require very large filters and are often incapable of removing debris such as sticks and leaves. Large trickle filters are often installed that are expensive and require semi-frequent maintenance.

In reviewing prior in-ground modular tanks and plastic moulded tanks, Applicant has noted that prior attempts are set deep in the ground to prevent buoyancy (popping out of the ground). In such circumstances, an additional pumping well, multiple pumps, and/or an alarm system may be additionally required to lift the overflow discharge water above a discharge point to gain a gravity flow to the point of discharge. This adds substantially to the cost of an install, effectively doubling the cost of popular small, moulded underground tanks, so providing an additional pumping well can add significantly to the cost.

An object of the present invention is to ameliorate one or more of the aforementioned disadvantages of the prior art or to at least provide a useful alternative thereto.

### STATEMENT OF INVENTION

The invention according to one or more aspects is described herebelow and further defined in the independent claims. Some optional and/or preferred features of the invention are described herebelow and further defined in the dependent claims.

The present invention combines ribbed coils with heavy particulate material such as rock to anchor a water holding system in the form of a sub-ground reservoir in place in the ground against buoyancy forces. It allows for the overflow to be set much higher in the ground, achieving a gravity flow at the discharge point, without the need for a complicated set of pumping wells.

Accordingly, in one aspect of the invention there is provided:

A water holding system for installation in a hole in the ground, the hole lined with both a water-permeable layer in the form of a flexible sheet and a water-impermeable layer in the form of a film or sheet, the impermeable layer positioned exterior relative to the permeable layer, a plurality of permeable cylindrical columns in the form of stack permeable plastics coils defining a central corridor inside each column, the spaces between the columns being filled with a particulate filtration medium that allows water to flow between the particles, wherein:
at least one of the plurality of columns is an access column that includes an access pipe that extends inside the access column's central corridor from a low level of the hole upwardly to the upper level of the hole;
the access pipe is no more than 200 mm in diameter at its upper access end to limit access and the system has a water pump connected at or near the base of the access pipe to pump filtered water from the low level; and
at the base of the access column, extending in between the permeable layer and the impermeable layer, is a spacer layer structurally adapted to support the access column above the impermeable layer and to maintain a flow-facilitating space free of material of the particulate filtration medium under the permeable layer immediately under the access column.

### Water Holding System

The hole may be an inground pool, pond or other hole. The hole may be a redeployed swimming pool. The pool may be lined with concrete, with varying contours according to each different installation. The water holding system is advantageous as its modular column and particulate material components are mouldable to the shape of the hole to maximise water storage and make it easy to install.

The water permeable filtration medium may include coils of stacked agi pipes (“coil stacks”). The water permeable filtration medium may further include cut lengths of agi pipes arranged between the coils of stacked agi pipes. The water permeable filtration medium may further include a substrate such as gravel, sand or other collectively porous particulate media that is adapted to fill the hole and spaces between lengths of agi pipe, but preferably not within the lengths of agi pipe. The water permeable filtration medium may be adapted to be situated on top of or internal (with respect to the hole) to the impermeable layer. The substrate may be adapted to fill spaces between the stacked agi pipes in the entire hole or up to a desired level below ground level.

The water holding system may include substrate such as gravel, sand or other porous mediums to fill available cavities within the hole and be situated on top of the permeable layer. The substrate may be adapted to interfill available spaces between lengths of Agi pipe, whereby to reinforce the compression strength of the stacks so that when landscaped or otherwise covered over above, it can be used for walking on, riding or driving over, lawn growth and other typical uses for ground level earth.

The substrate and permeable layer may be adapted to filter out heavy particulates such as sticks, leaves, dirt, silt. The substrate may be adapted to drip or slow filter water. Furthermore, the substrates large cavities or porous nature of the substrate medium may allow for high volumes of water to be held in between substrate particulates and inside cavities of the agi pipes of the water permeable filtration medium. Advantageously, the heavy particulates or rock may hold down the water holding system preventing the water holding system from rising. The heavy particulates weight may be adapted to be above a buoyancy force of the water holding system such that the water holding system will not float or rise if the ground surrounding the water holding system is water-logged. The overall mass and distribution throughout the spaces of the heavy particulates is preferably sufficient if the water holding system was surrounded by water.

### Permeable Layer

The permeable layer may include fabrics such as cotton, hemp, wool. The permeable layer may include synthetic fabrics such as polyester wool or fibrous polyester mat. The permeable layer is preferably a geofabric material. The permeable layer is permeable to water and is adapted to be at last resistant to the passing through itself of silt, sand, gravel and dirt.

The permeably layer may line a bottom of the hole. Preferably, the permeable layer lines the entire hole.

### Impermeable Layer

The impermeable layer may include plastic film or sheet. The impermeable layer may include PVC, vinyl, or other plastics. Preferably, the impermeable layer is impermeable to water, silt, sand and gravel.

The impermeable layer may line a base of the hole. Preferably, the impermeable layer lines the entire hole.

Preferably, the permeable layers are placed between any surface and the impermeable layer. For example, the permeable layer may be adapted to be placed between the hole and the impermeable layer, between the substrate and the impermeable layer and between the spacer layer and the impermeable layer. Advantageously, the permeable layer may provide a surface protection for the impermeable layer to prevent the impermeable layer being pierced.

### Spacer Layer

The water holding system may further include a spacer layer. Preferably, the spacer layer provides a platform for the pump. The spacer layer may include hollow plastic panels or plastic panels with holes. The spacer layer may be adapted to be positioned between the impermeable layer and the permeable layer. Preferably the spacer layer is adapted to provide a debris-free zone from which water can be pumped to a ground surface. Preferably, debris is filtered out through the substrate and through the permeable layer such that filtered water is held in the spacer layer. The spacer layer may correspond with the location of a sump. The sump may be at the base of the access column.

Preferably, the spacer layer is extended through the sump as a corridor. The corridor may be 200 mm-1000 mm, more preferably about 300 mm-700 mm, even more preferably about 400 mm-600 mm, and most preferably about 500 mm wide along its length. Similar dimensions apply to its possible length. In terms of height, the spacer layer may be about 20 mm-100 mm, more preferably about 25 mm-70 mm, even more preferably about 30 mm-50 mm, and most preferably about 30 mm. The spacer layer is preferably positioned above the permeable layer and below the coil stacks. This arrangement advantageously increases water delivery to the access pipes. Such an arrangement is particularly applicable to commercial dig-out projects.

The provision of the spacer layer allows for larger pumps to be incorporated in the system for use on large commercial projects. The provision of the spacer layer facilitates fast flow of water at the sump whereby the system is operable with an access pipe diameter of no more than 200 mm, preferably no more than 150 mm, for safety purposes.

In an arrangement according to the invention where the access pipe is one of a pair of access pipes, the twin pipes preferably have a diameter of no more than 150 mm for safety purposes. This is particularly suitable for commercial projects. Indeed, the system enables the use of multiple small diameter access pipes for safety purposes to great effect because more than one column in the system can house an access pipe.

The spacer layer operates as a drainage cell, providing a void under the columns and particulate material for water to collect. The spacer layer also performs as a defined sump.

The spacer layer provides for multi directional flow of water. The flow rates achieved using a single access pipe may be consistent with the flow achieved by typical mains pressure in Australia (at least 100 kPa, typically 300-550 kPa, and ideally about 500 kPa). The system is therefore suited to installations for both the residential home and pool conversion markets where flow rates consistent with mains pressure are sufficient.

The system may include a 400 mm diameter spacer layer for domestic projects without a corridor. For smaller installations, the spacer layer may be no more than 400 mm wide. This may be sufficient for a smaller pump capacity to deliver the water to, for example, domestic irrigation installations, without the twin pipes running dry. It may also protect the permeable layer from the effects of pump vibrations.

The system is also suited to commercial projects where larger flow rates are required, whilst still maintaining the safety feature of small diameter access pipes.

### Valve

The water holding system may include a one-way valve positioned at a base of the water holding system. This is known as a hydrostatic valve or hydro-valve and it is a generally a building code requirement that pools be installed with such a valve at its lowest point in the pool space. The valve may be positioned centrally of the base of the water holding system. The valve may be adapted to be actuated to admit water from external to the water holding system. The valve may allow subterranean water that may rise to the low level to ingress into the water holding system to avoid the water holding system becoming buoyant. The valve inlet preferably has a screen, mesh or filter adapted to restrict dirt and debris entering the water holding system through the valve. The valve may be spring biased to a closed position. The outlet of the valve may include a cap biased to seal the outlet unless the pressure of water in the inlet is sufficient to displace the cap to an open position.

The hydrostatic valve is preferably incorporated in the system at the location of the sump, below the access pipe, within the footprint of the spacer layer and/or in the drainage cell. Pools mandatorily have a hydrostatic valve, and the system may advantageously include a second hydrostatic valve between the impermeable and permeable layers at the sump.

According to the invention, the water impermeable layer in the form of a plastic dam liner may be installed in reclaimed pool reservoirs to provide a water-tight seal. Problem ground water can get trapped between the concrete pool floor and the liner. To overcome this problem, the system may include a secondary hydrostatic valve installed in the water impermeable layer to allow ground water to flow up into the sump to prevent the pool from popping out of the ground.

### Agi Pipe

The first access pipe may be a pipe with holes through it. The first access pipe may be a PVC pipe with holes. The first access pipe may be a channel, cylindrical or otherwise that is adapted to be permeable to water. The first access pipe is preferably in the form of a vertically aligned length of Agi pipe.

The system may include a second access pipe. The second access pipe may be orientated vertically. The second access pipe may be adapted to receive a pole. The pole may be adapted to remove and replace the valve in situ. The pole may be adapted to rotate the valve or unscrew/screw the valve to remove or install the valve.

The first and second access pipes may be no larger than 150 mm in internal diameter. The second access pipe may be no larger than 250 mm in internal diameter.

The first access pipe is preferably deployed to terminate at its lower end with or adjacent a pump. The second access pipe is adapted to be located adjacent the first access pipe.

Using Agi pipe to form the access pipe provides better flow than simple cylindrical walled smooth-surface pipes with holes or perforations provided or formed therein. In the access pipe formed with Agri pipe, the corrugations are effective to provide small external voids that exclude particulate material immediately adjacent and about the cylindrical wall along the length of the pipe. The corrugations typically create an approximate 2-10 mm, preferably about 3-7 mm, and most preferably about 5 mm, intermittent or continuous cylindrical void around the pipe. The small adjacent voids facilitate flow of water all the way up the column.

The slots in Agi pipe are on the inner portion of the corrugations. In smooth perforated PVC pipe, the particulate material can block part, or all, of a slot, thereby restricting water from flowing into the cavity defined by the access pipe. The spacer layer and the narrow access pipe in the form of a corrugated, slotted shaft, produces excellent flow whilst preserving the safety aspect by minimising access to mitigate what would otherwise be a safety hazard.

The Agi pipe used for the access pipe has advantages for transport and storage. It is flexible for packaging purposes when shipping. This is advantageous for shipping installation kits providing the components of the water holding system sans particulate material. Typically, a length of the Agi pipe for the access pipe shaft is 1-2.5 m, preferably 1.5-2 m, and most preferably about 1.8 m long, for a pool conversion or other installation of the system. The flexible Agi access pipe can be folded in half for transport and storage purposes. This reduces its length by more than a half so that it fits into a standard size box under 900 mm, which parcel dimension is a restriction that may be imposed by freight companies. In this way, freight transport is possible at minimum cost.

The arrangement of the water holding system comprises a combination of agi coil and particulate rock. It preferably includes the space saver. Alternatively, or in addition, the system includes the secondary hydrostatic valve. Also, alternatively or in addition, the system includes the corrugated shaft comprising Agi pipe as the access pipe.

### Inlet Valve

The water holding system may further include an inlet valve. The inlet valve may be adapted to provide a gross filter to remove sticks, leaves, or other large debris. It may be adapted to feed water directly into the hole through a side inlet formed in a side of a wall of the hole.

### Surface and Drainage

The system may include a permeable top cover at and immediately below ground level. The cover preferably extends across the entire expanse of the mouth of the hole. The system may therefore be effective to maintain lawn or garden soil above the hole. The layer of soil may extend to a depth from the ground surface of between 100-500 mm, preferably 150-300 mm, most preferably about 200 mm, in a vertical direction.

The top cover includes a permeable layer. This permeable layer may include a layer of crushed rock or clay, the crushed rock or clay layer having a depth of between 10⁻⁵⁰ mm, preferably 15-30 mm, most preferably about 20 mm, in the vertical direction. The crushed rock of layer may comprise the same material as the substrate, or may be finer in that the individual particles are smaller on average. The permeable layer acts as a filter for water draining from the top soil.

The permeable layer may further include a permeable sheet layer. The permeable sheet layer is preferably in the form of a sheet of geofabric, although it could comprise synthetic unwoven mesh material, or natural fibre mesh materials including hessian or core fibre mesh. The permeable sheet layer preferably extends across the entire mouth, at its periphery preferably overlapping or abutting the permeable sheet layer that, with the impermeable layer, lines the hole.

Immediately below the permeable layer, the substrate may be in the form of rock screenings or other particulate material. The substrate may act as part of the filtration system to provide stability and vertical compression strength to the system. The substrate may support activities on the ground immediately there above. The substrate is used to fill the interstitial spaces between the coil stacks and in the internal cylindrical columns defined by the stacks, but is excluded from the internal spaces of the pipes themselves due to the small apertures and perforations throughout the length of the pipe. The coil stacks and substrate are present throughout the hole below the permeable layer and above the base.

The system provides a source of moisture to grow plants immediately above the system in the top soil. The system may support an enclosed plant and vegetation bed founded on and in the top soil. The support is structural to enable activities to go on at ground surface and above as if it is a normal patch of lawn with no cavity in the form of the hole therebelow. The structural support comprises, in part, the slotted coil stacks and the rock screenings. This compacted, enclosed and restrictive system may provide a moist underbelly for the vegetation bed in the top soil immediately above. This is aesthetically and functionally advantageous to users of the space above the system.

The permeable geofabric sheet layer constitutes part of the top cover. The geofabric sheet layer underlies the layer of crushed rock or clay and is positioned underneath the soil. This may have the effect of slowing down filtration into the system, more particularly the interstitial spaces amongst the substrate and coil stacks. This maintains moisture in the top soil.

The present inventive system is unlike prior art systems where water drains quickly into a reservoir. Prior art reservoirs are typically covered with an impermeable plastic layer (eg PVC) so as to grow plant life above, thus missing out on surface water collection and potentially creating drainage issues around their prior art systems. The prior art may provide a pervious lid for soak pits or detention systems, but these are not water holding systems for potable water as the top soil would simple dry out too quickly to support plant life.

The system is advantageous in that not only can it collect roof and surface water, but may have the added benefit of solving onsite drainage issues at ground level.

In another aspect of the invention, the system may provide a water drainage, filtration and storage system that has the same features as previously described, with the exception that it provides a hybrid lower-part storage and top part enhanced drainage portion. The hybrid system may include the stacks, the substrate, the impermeable and impervious layers, the sump and pump systems, and inflow and outflow pipes, as for the above described system.

However, in the hybrid system, the impervious sheet in the form of a dam liner, for example an impermeable plastics sheeting such as PVC liner, extends only partway up the side walls of the hole. The upper edge of the impermeable liner may terminate part way up the walls of the hole, for example, about half way up the walls of the hole. The permeable layer in the form of geofabric lines the internal side of the impermeable layer and continues to the top of the hole, for example to ground level. The overflow provides an outlet to deter the water level in the hole from going higher than the upper edge of the impermeable liner. The overflow is preferably at or around the same level as the impermeable liner upper edge. The overflow is therefore preferably located at a level equal to part way up the sump, preferably about half way up the sump, and in any case, immediately below the upper edge of the impermeable liner.

It will be appreciated that any of the features described herein can be used in any combination, and that the invention as described in respect of the second aspect may have the specific features referred to above in respect of the invention as described in respect of the first aspect.

### BRIEF DESCRIPTION OF THE DRAWINGS

The invention may be better understood from the following non-limiting description of preferred embodiments, in which:

FIG. 1A is a cross-section of a water holding system;

FIG. 1B is a close-up cross-sectional view of multiple permeable, an impermeable and a spacer layer of the water holding system;

FIG. 1C is a close-up cross-sectional view of a impermeable sandwiched between two permeable layers of the water holding system;

FIG. 2 is a close-up cross-sectional view of a valve of the water holding system;

FIG. 3 is an under-side view of the valve of the water holding system;

FIG. 4 is a top side view of the valve of the water holding system;

FIG. 5 is a schematic cross-sectional view of a water holding system according to a second embodiment; and

FIG. 6 is a schematic exposed view of a water holding tank according to a third embodiment.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. In describing the various embodiments of the invention, like features will be referred to using like references, with references for features of each embodiment generally preceded by 1, 2, 3, or followed by a Roman numeric sequence, such as i, ii, iii, etc. or an alphabetical sequence such as a, b, c, relative to the corresponding feature of the first embodiment. For example, a feature 10 of the first embodiment may represented as 110, 210, 310, (or n10), or 10a, 10b, 10c, (or 10x) or 10i, 10ii, 10iii, (or 10r) etc. in second, third and fourth embodiments, respectively.

Reference is made to Applicant's previous published patent application No. AU2021269296, the entire contents of which are hereby incorporated into the present specification.

A water holding system 1 including lining a hole 2 with both a permeable 10 and impermeable 20 to water layer in the form of a film or sheet, the impermeable layer 20 positioned exterior relative to the permeable layer 10. The hole 2 is filled with a water permeable filtration medium 3a, wherein the water holding system 1 includes a valve 30 positioned at a base 1a of the water holding system 1 and a first access pipe 40 including Agi pipe extending from the valve 30 to ground level 4.

### Water Holding System

The hole 2 may be an inground pool, pond or other hole.

The water permeable filtration medium includes coils of stacked agi pipes 3bi. It optionally includes cut lengths of agi pipes 3bii arranged between the coils of stacked agi pipes 3bi to further occupy interstitial cavities between the stacked columns 3bi. The water permeable filtration medium further includes a substrate 3c such as gravel, sand or other porous mediums is adapted to fill the hole 2 and spaces between the agi pipes 3bi,3bii. The water permeable filtration medium 3a is adapted to be situated on top of the permeable layer 10. The substrate 3c is adapted to fill the remaining available spaces in the hole 2 not excluded by Agi pipe, for example, up to a desired level below ground level 4.

The substrate 3c is adapted to filter out heavy particulates such as sticks, leaves, dirt, silt. The substrate 3c is adapted to drip or slow filter water. Furthermore, the substrate's 3c large cavities or the porous nature of the substrate 3c medium may allow for high volumes of water to be held in between substrate 3c particulates in the spaces outside the Agi pipe 3bi.

The substrate 3c is in the form of heavy particulates, such as screenings or rock, the particles having an average diameter of 10⁻²⁵ mm, a density of 1.3-1.7 T/m³, and a volume of around 1000-3000 mm³ (1-3×10⁻⁶ m³). The substrate 3c is sufficient to hold down the water holding system, preventing the water holding system from rising with any rise in ground water. The collective mass and distribution through the spaces of the heavy particulates of the substrate 3c is advantageously above a buoyancy force of the water holding system. Accordingly, the water holding system, particularly the water impermeable layer 20, and/or the concrete or plastic defining the hole 2, will not float or rise if the ground surrounding the water holding system 1 is water-logged or the water table level in the immediate vicinity and surrounds rises above the base 1a. The overall mass and distribution throughout the spaces of the heavy particulates of the substrate 3c is sufficient to overcome the buoyancy force of the water holding system 1 if the water holding system 1 is surrounded by a rising water table at a level above the base 1a.

### Permeable Layer

The permeable layer 10 is made from a synthetic wool in the form of a mat. The permeable layer is permeable to water but is adapted to be impermeable or to at least limit the passage through itself of silt, sand, gravel, and dirt. In other words, the permeable layer 10 acts as a first level filter or a filter sheet, the Agi pipe 3bi and substrate 3c performing subsequent filtration functions as the water moves from the top 2a of the hole 2 to the bottom 2b of the hole 2 or the base 1a.

The permeable layer 10 preferably lines the entire hole 2.

### Impermeable Layer

The impermeable layer 20 is a flexible sheet material. The impermeable layer 20 is made from materials such as a PVC sheet or other plastic sheets that are impermeable to water, silt, sand and gravel.

The impermeable layer 20 preferably lines the hole 2 at least up to a maximum internal water level. More preferably, the impermeable layer 20 lines the entire hole 2.

### Spacer Layer

The water holding system 1 further includes a spacer layer 50. The spacer layer 50 includes hollow and permeable plastic panels with spacer holes 52. The spacer layer 50 is ideally positioned between the impermeable layer 20 and the permeable layer 10. The spacer layer 50 is adapted to provide a debris-free zone from which water can be pumped to the ground surface 4 with a pump 54. The water holding system 1 includes a filtered water access pipe 44 adapted to house the pump 54 inline. The access pipe 44 is adapted to be located adjacent the first access pipe 42. The first and second access pipes 42,44 are adapted to be positioned vertically and to extend through the stacked agi pipes 3bi (stacked coil of agi pipes). The pump 54 is adapted to pump water from the base 1a of the water holding system 1 and out through a clean water pipe 55. Debris is filtered out through the substrate 3c and through the permeable layer 10 and filtered water is held in any cavities such as inside the agi pipes 3bi, 3bii and between the substrate particles 3c.

The spacer layer 50 creates a substrate free zone between the permeable layer 10 and the impermeable layer 20. The spacer layer 50 also provides a noise absorbing platform on which the pump 54 rests.

The spacer layer 50 is in the location of a sump at the base of first access pipe 42. The spacer layer 50 is located at the base 1a in the vicinity under the valve 30. The spacer layer 50 in this location provides a defined protected space for clean water to collect. It provides a defined volume from which clean water may be extracted with reduced flow resistance. There may be less strain on the pump 54 as an inline filter may not be necessary. Minimising loading on the pump 54 is useful to ameliorate the unavoidable loading of gravitational pull against upward extraction of clean water from the spacer layer 50 in the form of the sump or clean water reservoir.

The spacer layer 50 extends through the sump as a corridor. The corridor is about 500 mm wide and long, and is about 30 mm in height, thereby defining a void volume of about 0.0075 m³ (7500 cm³). The spacer layer 50 is positioned above the permeable layer 10 and below the coil stacks 3bi. This arrangement advantageously decreases the energy needed for pumping the water from the spacer layer 50 upward to deliver water to the access pipes 42,44.

The spacer layer 50 operates as a drainage cell, providing the void volume of around 0.005-0.01 m³ under the columns 3bi and particulate material 3c for water to collect in the effective sump defined by the spacer layer 50. The spacer layer 50 provides for multi directional flow of water. The flow rates achieved using a single access pipe may be consistent with the flow achieved by typical mains pressure in Australia (at least 100 kPa, typically 300-550 kPa, and ideally about 500 kPa).

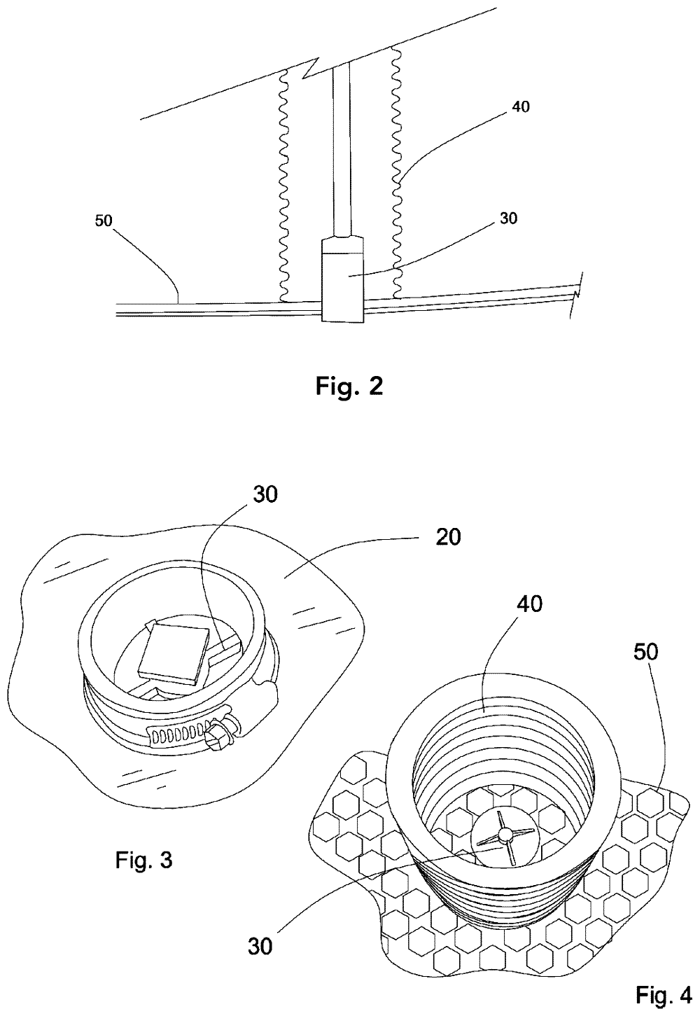

The valve 30 may be positioned centrally on the base 1a of the water holding system 1 and may be accessible via the first access pipe 42. The valve 30 is a one-way valve adapted to automatically admit water under pressure and against the check valve's bias from exterior to the base 1a of the hole 2 through the impermeable layer 20 to inside hole 2 through the permeable layer 10. The valve 30 extends through the impermeable layer 20 as shown in FIG. 2. The valve 30 is adapted to release pressure build up underneath the impermeable layer 20. A manual rod 60 may be used to manipulate a cap of the valve 30 to unscrew the cap and permit repair or replacement.

The valve 30 is advantageously hydrostatic and is incorporated in the system 1 at the location of the sump (spacer layer 50), below the access pipe 42, and within the footprint of the spacer layer 50.

The water impermeable layer in the form of a plastic dam liner 20 is advantageously installed in the hole 2 to provide a water-tight seal. The hole 2 may be a reclaimed pool reservoir, from or for which the hole 2 was formed. The system 1 includes a the hydrostatic valve 30 installed in the water impermeable layer 20 to allow ground water to flow up into the sump to prevent the pool from popping out of the ground.

### Access Pipe

The first access pipe 42 is a pipe with holes through it. This can be, for example, in the form of agi pipe or or slotted PCV pipe, with Agi pipe being preferred inter alia to minimise the complexity of the system by having fewer different components or materials. The first and second access pipes 42,44 are adapted to be permeable to water.

The first access pipe 42 is orientated vertically. The first access pipe 42 is adapted to receive the rod or pole 60. The pole 60 is adapted to dislodge and/or release the cap, e.g. by rotating the valve 30 or unscrewing/screwing the valve 30 by means of a claw, hook, or pincer.

The first access pipe 42 is no larger than 150 mm in internal diameter. This is advantageous to limit the danger of small children or animals getting caught in this upper accessible part of the system 1.

### Inlet Valve

The water holding system 1 further includes an inlet valve 70. The inlet valve 70 includes a first filter to remove sticks, leaves, or other large debris. The inlet valve 70 is adapted to feed water directly into the substrate 3 through the impermeable layer 20. The inlet valve is adapted to receive stormwater from stormwater plumbing 72.

### Surface and Drainage

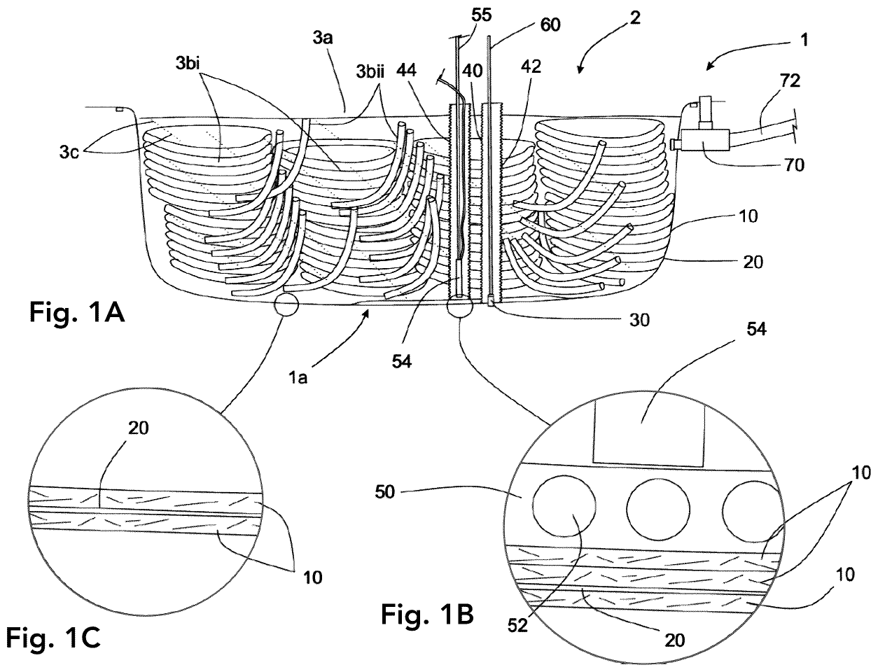

Referring particularly to FIGS. 1A-C and 5, the system 1 includes a permeable top cover 80 at and immediately below ground level 4. The cover 80 preferably extends across the entire expanse of the mouth 2a of the hole 2. The system 1 may therefore be effective to maintain lawn or garden soil 81 above the hole 2. The layer of soil 81 may extend to a depth from the ground surface 4 of between 100-500 mm, preferably 150-300 mm, most preferably about 200 mm, in a vertical direction.

The top cover 80 includes a permeable layer 82,83. This permeable layer may include a layer of crushed rock or clay 82, the crushed rock or clay layer 82 having a depth of between 10-50 mm, preferably 15-30 mm, most preferably about 20 mm, in the vertical direction. The crushed rock of layer 82 may comprise the same material as the substrate 3c, or may be finer in that the individual particles are smaller on average. The permeable layer acts as a filter for water draining from the top soil 81.

The permeable layer may further include a permeable sheet layer 83. The permeable sheet layer 83 is preferably in the form of a sheet of geofabric 12, although it could comprise synthetic unwoven mesh material, or natural fibre mesh materials including hessian or core fibre mesh. The permeable sheet layer 83 preferably extends across the entire mouth 2a, at its periphery preferably overlapping or abutting the permeable sheet layer 10 that, with the impermeable layer 20, lines the hole 2.

The system 1 provides a source of moisture to grow plants immediately above the system 1 in the top soil 81. The system 1 may support an enclosed plant and vegetation bed founded on and in the top soil 81. The support is structural to enable activities to go on at ground surface and above as if it is a normal patch of lawn with no cavity in the form of the hole 2 therebelow. The structural support comprises, in part, the slotted coil stacks 3bi and the rock screenings 3c. This compacted, enclosed and restrictive system 1 provides a moist underbelly for the vegetation bed in the top soil 81 immediately above. This is aesthetically and functionally advantageous to users of the space above the system 1.

The permeable geofabric sheet layer 83 constitutes part of the top cover 80. The geofabric sheet layer 83 underlies the layer of crushed rock or clay 82 and is positioned underneath the soil 81. This may have the effect of slowing down filtration into the system 1, more particularly the interstitial spaces amongst the substrate 3c and coil stacks 3bi. This maintains moisture in the top soil 81.

Immediately below the permeable layer 83, the substrate 3c in the form of rock screenings is used to fill the interstitial spaces between the coil stacks 3bi and in the internal cylindrical columns defined by the stacks 3bi. The coil stacks 3bi and substrate 3c are present throughout the hole 2 below the permeable layer 83 and above the base 1a.

In another embodiment of the invention shown in FIG. 6, there is provided a water drainage, filtration and storage system 101 that has the same features as system 1, with the exception that it provides a hybrid lower-part storage 102 and top part enhanced drainage portion 180.

The system 101 includes the stacks 3bi, the substrate 3c, the impermeable and impervious layers 10,20, the sump and pump systems and inflow and outflow pipes, as for system 1. However, in the system 101, the impervious sheet 120 in the form of a dam liner, for example an impermeable plastics sheeting such as PVC liner, extends only partway up the side walls of the hole 102. The upper edge 122 of the impermeable liner 120 may terminate part way up the walls of the hole 102, for example, about half way up the walls of the hole 2. The permeable layer 10 in the form of geofabric lines the internal side of the impermeable layer 20 and continues to the top of the hole 2, for example to ground level 4. The overflow 115 provides an outlet to deter the water level in the hole from going higher than the upper edge 122 of the impermeable liner 120. The overflow 115 is therefore preferably located part way up the sump, preferably about half way up the sump. This is preferably at the same level as the impermeable liner upper edge 122.

### Definitions, Meanings, Qualifications and Explanations

Throughout the specification and claims the word “comprise” and its derivatives are intended to have an inclusive rather than exclusive meaning unless the contrary is expressly stated, or the context requires otherwise. That is, the word “comprise” and its derivatives will be taken to indicate the inclusion of not only the listed components, steps, or features that it directly references, but also other components, steps or features not specifically listed, unless the contrary is expressly stated, or the context requires otherwise.

“Agi pipe” is a corrugated drainage pipe made from plastic material that is typically used to drain ground water in domestic and agricultural applications, as well as construction and road projects. The light-weight corrugated pipe is typically cylindrical and flexible. It has regularly slotted openings along its length to allow drainage.

In the present specification, terms such as “apparatus”, “means”, “device” and “member” may refer to singular or plural items and are terms intended to refer to a set of properties, functions or characteristics performed by one or more items or components having one or more parts. It is envisaged that where an “apparatus”, “means”, “device” or “member” or similar term is described as being a unitary object, then a functionally equivalent object having multiple components is considered to fall within the scope of the term, and similarly, where an “apparatus”, “assembly”, “means”, “device” or “member” is described as having multiple components, a functionally equivalent but unitary object is also considered to fall within the scope of the term, unless the contrary is expressly stated or the context requires otherwise.

In the present specification, the phrase “and/or” refers to severally or any combination of the features. For example, the phrase “feature 1, feature 2 and/or feature 3” includes within its scope any one of the following combinations: Feature 1 or feature 2 or feature 3; feature 1 and feature 2 or feature 3; feature 1 or feature 2 and feature 3; feature 1 and feature 3 or feature 2; feature 1 and feature 2 and feature 3.

The meaning of descriptive, precise, or absolute terms such as “flexed”, “normal”, “parallel”, “horizontal”, “vertical” or “fully” includes the preceding qualifier “substantially or almost”, unless the context or contrary is expressly indicated, which may be taken to indicate a variation in an absolute value of between 0° and 10° or between 0% and 10%, relative to the absolute value of the term.

Qualifying relative terms, such as “relatively”, “sufficiently”, “near”, “almost” or “substantially”, may be taken to indicate a variation in an absolute value of between 0° and 10° or between 0% and 10%, relative to the absolute value. For example, “near horizontal” may be taken to mean any orientation between 0° and 10° relative to the horizontal.

If the word “for” is used to qualify a use or application of an object term, it is only limiting in the sense that the device or component should be “suitable for” that use or application.

In the present specification, the term “integral” means formed of one body in a single process.

In particular, the term “integrally formed” means formed of the one body without post-forming attachment of separately formed component parts. That is, “integrally formed” and the similar term “unitarily formed” mean formed in a single forming process and do not include post-forming attachment of component parts by means of fastener or other component fixing substances or methods.

Orientational terms used in the specification and claims such as vertical, horizontal, top, bottom, upper and lower are to be interpreted as relational and are based on the premise that the component, item, article, apparatus, device, or instrument will usually be considered in a particular orientation, for example with the coil stacks standing upright and the access pipes aligned substantially vertically.

In the present specification, the term “integral” means formed of one body in a single process. In particular, the term “integrally formed” means formed of the one body without post-forming attachment of separately formed component parts. That is, “integrally formed” and the similar term “unitarily formed” mean formed in a single forming process and do not include post-forming attachment of component parts by means of fastener or other component fixing substances or methods.

The articles “a” and “an” are used herein to refer to one or to more than one (i.e. to at least one) of the grammatical object of the article. By way of example, “an element” means one element or more than one element.

It will be appreciated by those skilled in the art that many modifications and variations may be made to the methods of the invention described herein without departing from the spirit and scope of the invention. The features and components of each of the embodiments of the invention described in the detailed description and/or depicted in the accompanying drawings may be interchangeable as required, with regard to functional equivalency and compatibility. A feature or component described with reference to one but not all embodiments, if functionally and dimensionally compatible as an addition with another embodiment herein described, or substitutable with a corresponding feature or component of that other embodiment in relation to which it has not been expressly described, should be read as a potential addition or substitution to that other embodiment and as being within the scope of the invention. Furthermore, in considering a feature or component that is described in relation a particular embodiment but may be omitted from the embodiment without losing the functionality characterising the invention and without departing from the scope of the invention, unless the context and expressions used in describing the embodiment imputes that the feature or component is essential to the invention as broadly described, the omittable feature or component may be read as not being included in the embodiment.

### Water Holding System

This application is a Convention Application claiming priority from Australian Provisional Patent Application Nos. 2024900762 and 2024901818 respectively filed on 21 Mar. 2024 and 14 Jun. 2024, the entire contents of which are hereby incorporated by reference.

### FIELD OF INVENTION

This invention relates to a hole for a water holding system. More particularly, this invention relates to water holding system including films or sheets set in existing holes.

### BACKGROUND ART

The following references to and descriptions of prior proposals or products are not intended to be, and are not to be construed as, statements or admissions of common general knowledge in the art. In particular, the following prior art discussion should not be assumed to relate to what is commonly or well known by the person skilled in the art, but to assist in the inventive process undertaken by the inventor and in the understanding of the invention.

Old pools or ponds lack filtration if refilled with water. Furthermore, filtration setups often require very large filters and are often incapable of removing debris such as sticks and leaves. Large trickle filters are often installed that are expensive and require semi-frequent maintenance.

In reviewing prior in-ground modular tanks and plastic moulded tanks, Applicant has noted that prior attempts are set deep in the ground to prevent buoyancy (popping out of the ground). In such circumstances, an additional pumping well, multiple pumps, and/or an alarm system may be additionally required to lift the overflow discharge water above a discharge point to gain a gravity flow to the point of discharge. This adds substantially to the cost of an install, effectively doubling the cost of popular small, moulded underground tanks, so providing an additional pumping well can add significantly to the cost.

An object of the present invention is to ameliorate one or more of the aforementioned disadvantages of the prior art or to at least provide a useful alternative thereto.

### STATEMENT OF INVENTION

The invention according to one or more aspects is described herebelow and further defined in the independent claims. Some optional and/or preferred features of the invention are described herebelow and further defined in the dependent claims.

The present invention combines ribbed coils with heavy particulate material such as rock to anchor a water holding system in the form of a sub-ground reservoir in place in the ground against buoyancy forces. It allows for the overflow to be set much higher in the ground, achieving a gravity flow at the discharge point, without the need for a complicated set of pumping wells.

Accordingly, in one aspect of the invention there is provided:

A water holding system for installation in a hole in the ground, the hole lined with both a water-permeable layer in the form of a flexible sheet and a water-impermeable layer in the form of a film or sheet, the impermeable layer positioned exterior relative to the permeable layer, a plurality of permeable cylindrical columns in the form of stack permeable plastics coils defining a central corridor inside each column, the spaces between the columns being filled with a particulate filtration medium that allows water to flow between the particles, wherein:
at least one of the plurality of columns is an access column that includes an access pipe that extends inside the access column's central corridor from a low level of the hole upwardly to the upper level of the hole;
the access pipe is no more than 200 mm in diameter at its upper access end to limit access and the system has a water pump connected at or near the base of the access pipe to pump filtered water from the low level; and
at the base of the access column, extending in between the permeable layer and the impermeable layer, is a spacer layer structurally adapted to support the access column above the impermeable layer and to maintain a flow-facilitating space free of material of the particulate filtration medium under the permeable layer immediately under the access column.

### Water Holding System

The hole may be an inground pool, pond or other hole. The hole may be a redeployed swimming pool. The pool may be lined with concrete, with varying contours according to each different installation. The water holding system is advantageous as its modular column and particulate material components are mouldable to the shape of the hole to maximise water storage and make it easy to install.

The water permeable filtration medium may include coils of stacked agi pipes (“coil stacks”). The water permeable filtration medium may further include cut lengths of agi pipes arranged between the coils of stacked agi pipes. The water permeable filtration medium may further include a substrate such as gravel, sand or other collectively porous particulate media that is adapted to fill the hole and spaces between lengths of agi pipe, but preferably not within the lengths of agi pipe. The water permeable filtration medium may be adapted to be situated on top of or internal (with respect to the hole) to the impermeable layer. The substrate may be adapted to fill spaces between the stacked agi pipes in the entire hole or up to a desired level below ground level.

The water holding system may include substrate such as gravel, sand or other porous mediums to fill available cavities within the hole and be situated on top of the permeable layer. The substrate may be adapted to interfill available spaces between lengths of Agi pipe, whereby to reinforce the compression strength of the stacks so that when landscaped or otherwise covered over above, it can be used for walking on, riding or driving over, lawn growth and other typical uses for ground level earth.

The substrate and permeable layer may be adapted to filter out heavy particulates such as sticks, leaves, dirt, silt. The substrate may be adapted to drip or slow filter water. Furthermore, the substrates large cavities or porous nature of the substrate medium may allow for high volumes of water to be held in between substrate particulates and inside cavities of the agi pipes of the water permeable filtration medium. Advantageously, the heavy particulates or rock may hold down the water holding system preventing the water holding system from rising. The heavy particulates weight may be adapted to be above a buoyancy force of the water holding system such that the water holding system will not float or rise if the ground surrounding the water holding system is water-logged. The overall mass and distribution throughout the spaces of the heavy particulates is preferably sufficient if the water holding system was surrounded by water.

### Permeable Layer

The permeable layer may include fabrics such as cotton, hemp, wool. The permeable layer may include synthetic fabrics such as polyester wool or fibrous polyester mat. The permeable layer is preferably a geofabric material. The permeable layer is permeable to water and is adapted to be at last resistant to the passing through itself of silt, sand, gravel and dirt.

The permeably layer may line a bottom of the hole. Preferably, the permeable layer lines the entire hole.

### Impermeable Layer

The impermeable layer may include plastic film or sheet. The impermeable layer may include PVC, vinyl, or other plastics. Preferably, the impermeable layer is impermeable to water, silt, sand and gravel.

The impermeable layer may line a base of the hole. Preferably, the impermeable layer lines the entire hole.

Preferably, the permeable layers are placed between any surface and the impermeable layer. For example, the permeable layer may be adapted to be placed between the hole and the impermeable layer, between the substrate and the impermeable layer and between the spacer layer and the impermeable layer. Advantageously, the permeable layer may provide a surface protection for the impermeable layer to prevent the impermeable layer being pierced.

### Spacer Layer

The water holding system may further include a spacer layer. Preferably, the spacer layer provides a platform for the pump. The spacer layer may include hollow plastic panels or plastic panels with holes. The spacer layer may be adapted to be positioned between the impermeable layer and the permeable layer. Preferably the spacer layer is adapted to provide a debris-free zone from which water can be pumped to a ground surface. Preferably, debris is filtered out through the substrate and through the permeable layer such that filtered water is held in the spacer layer. The spacer layer may correspond with the location of a sump. The sump may be at the base of the access column.

Preferably, the spacer layer is extended through the sump as a corridor. The corridor may be 200 mm-1000 mm, more preferably about 300 mm-700 mm, even more preferably about 400 mm-600 mm, and most preferably about 500 mm wide along its length. Similar dimensions apply to its possible length. In terms of height, the spacer layer may be about 20 mm-100 mm, more preferably about 25 mm-70 mm, even more preferably about 30 mm-50 mm, and most preferably about 30 mm. The spacer layer is preferably positioned above the permeable layer and below the coil stacks. This arrangement advantageously increases water delivery to the access pipes. Such an arrangement is particularly applicable to commercial dig-out projects.

The provision of the spacer layer allows for larger pumps to be incorporated in the system for use on large commercial projects. The provision of the spacer layer facilitates fast flow of water at the sump whereby the system is operable with an access pipe diameter of no more than 200 mm, preferably no more than 150 mm, for safety purposes.

In an arrangement according to the invention where the access pipe is one of a pair of access pipes, the twin pipes preferably have a diameter of no more than 150 mm for safety purposes. This is particularly suitable for commercial projects. Indeed, the system enables the use of multiple small diameter access pipes for safety purposes to great effect because more than one column in the system can house an access pipe.

The spacer layer operates as a drainage cell, providing a void under the columns and particulate material for water to collect. The spacer layer also performs as a defined sump.

The spacer layer provides for multi directional flow of water. The flow rates achieved using a single access pipe may be consistent with the flow achieved by typical mains pressure in Australia (at least 100 kPa, typically 300-550 kPa, and ideally about 500 kPa). The system is therefore suited to installations for both the residential home and pool conversion markets where flow rates consistent with mains pressure are sufficient.

The system may include a 400 mm diameter spacer layer for domestic projects without a corridor. For smaller installations, the spacer layer may be no more than 400 mm wide. This may be sufficient for a smaller pump capacity to deliver the water to, for example, domestic irrigation installations, without the twin pipes running dry. It may also protect the permeable layer from the effects of pump vibrations.

The system is also suited to commercial projects where larger flow rates are required, whilst still maintaining the safety feature of small diameter access pipes.

The water holding system may include a one-way valve positioned at a base of the water holding system. This is known as a hydrostatic valve or hydro-valve and it is a generally a building code requirement that pools be installed with such a valve at its lowest point in the pool space. The valve may be positioned centrally of the base of the water holding system. The valve may be adapted to be actuated to admit water from external to the water holding system. The valve may allow subterranean water that may rise to the low level to ingress into the water holding system to avoid the water holding system becoming buoyant. The valve inlet preferably has a screen, mesh or filter adapted to restrict dirt and debris entering the water holding system through the valve. The valve may be spring biased to a closed position. The outlet of the valve may include a cap biased to seal the outlet unless the pressure of water in the inlet is sufficient to displace the cap to an open position.

The hydrostatic valve is preferably incorporated in the system at the location of the sump, below the access pipe, within the footprint of the spacer layer and/or in the drainage cell. Pools mandatorily have a hydrostatic valve, and the system may advantageously include a second hydrostatic valve between the impermeable and permeable layers at the sump.

According to the invention, the water impermeable layer in the form of a plastic dam liner may be installed in reclaimed pool reservoirs to provide a water-tight seal. Problem ground water can get trapped between the concrete pool floor and the liner. To overcome this problem, the system may include a secondary hydrostatic valve installed in the water impermeable layer to allow ground water to flow up into the sump to prevent the pool from popping out of the ground.

### Agi Pipe

The first access pipe may be a pipe with holes through it. The first access pipe may be a PVC pipe with holes. The first access pipe may be a channel, cylindrical or otherwise that is adapted to be permeable to water. The first access pipe is preferably in the form of a vertically aligned length of Agi pipe.

The system may include a second access pipe. The second access pipe may be orientated vertically. The second access pipe may be adapted to receive a pole. The pole may be adapted to remove and replace the valve in situ. The pole may be adapted to rotate the valve or unscrew/screw the valve to remove or install the valve.

The first and second access pipes may be no larger than 150 mm in internal diameter. The second access pipe may be no larger than 250 mm in internal diameter.

The first access pipe is preferably deployed to terminate at its lower end with or adjacent a pump. The second access pipe is adapted to be located adjacent the first access pipe.

Using Agi pipe to form the access pipe provides better flow than simple cylindrical walled smooth-surface pipes with holes or perforations provided or formed therein. In the access pipe formed with Agri pipe, the corrugations are effective to provide small external voids that exclude particulate material immediately adjacent and about the cylindrical wall along the length of the pipe. The corrugations typically create an approximate 2-10 mm, preferably about 3-7 mm, and most preferably about 5 mm, intermittent or continuous cylindrical void around the pipe. The small adjacent voids facilitate flow of water all the way up the column.

The slots in Agi pipe are on the inner portion of the corrugations. In smooth perforated PVC pipe, the particulate material can block part, or all, of a slot, thereby restricting water from flowing into the cavity defined by the access pipe. The spacer layer and the narrow access pipe in the form of a corrugated, slotted shaft, produces excellent flow whilst preserving the safety aspect by minimising access to mitigate what would otherwise be a safety hazard.

The Agi pipe used for the access pipe has advantages for transport and storage. It is flexible for packaging purposes when shipping. This is advantageous for shipping installation kits providing the components of the water holding system sans particulate material. Typically, a length of the Agi pipe for the access pipe shaft is 1-2.5 m, preferably 1.5-2 m, and most preferably about 1.8 m long, for a pool conversion or other installation of the system. The flexible Agi access pipe can be folded in half for transport and storage purposes. This reduces its length by more than a half so that it fits into a standard size box under 900 mm, which parcel dimension is a restriction that may be imposed by freight companies. In this way, freight transport is possible at minimum cost.

The arrangement of the water holding system comprises a combination of agi coil and particulate rock. It preferably includes the space saver. Alternatively, or in addition, the system includes the secondary hydrostatic valve. Also, alternatively or in addition, the system includes the corrugated shaft comprising Agi pipe as the access pipe.

### Inlet Valve

The water holding system may further include an inlet valve. The inlet valve may be adapted to provide a gross filter to remove sticks, leaves, or other large debris. It may be adapted to feed water directly into the hole through a side inlet formed in a side of a wall of the hole.

### Surface and Drainage

The system may include a permeable top cover at and immediately below ground level. The cover preferably extends across the entire expanse of the mouth of the hole. The system may therefore be effective to maintain lawn or garden soil above the hole. The layer of soil may extend to a depth from the ground surface of between 100-500 mm, preferably 150-300 mm, most preferably about 200 mm, in a vertical direction.

The top cover includes a permeable layer. This permeable layer may include a layer of crushed rock or clay, the crushed rock or clay layer having a depth of between 10⁻⁵⁰ mm, preferably 15-30 mm, most preferably about 20 mm, in the vertical direction. The crushed rock of layer may comprise the same material as the substrate, or may be finer in that the individual particles are smaller on average. The permeable layer acts as a filter for water draining from the top soil.

The permeable layer may further include a permeable sheet layer. The permeable sheet layer is preferably in the form of a sheet of geofabric, although it could comprise synthetic unwoven mesh material, or natural fibre mesh materials including hessian or core fibre mesh. The permeable sheet layer preferably extends across the entire mouth, at its periphery preferably overlapping or abutting the permeable sheet layer that, with the impermeable layer, lines the hole.

Immediately below the permeable layer, the substrate may be in the form of rock screenings or other particulate material. The substrate may act as part of the filtration system to provide stability and vertical compression strength to the system. The substrate may support activities on the ground immediately there above. The substrate is used to fill the interstitial spaces between the coil stacks and in the internal cylindrical columns defined by the stacks, but is excluded from the internal spaces of the pipes themselves due to the small apertures and perforations throughout the length of the pipe. The coil stacks and substrate are present throughout the hole below the permeable layer and above the base.

The system provides a source of moisture to grow plants immediately above the system in the top soil. The system may support an enclosed plant and vegetation bed founded on and in the top soil. The support is structural to enable activities to go on at ground surface and above as if it is a normal patch of lawn with no cavity in the form of the hole therebelow. The structural support comprises, in part, the slotted coil stacks and the rock screenings. This compacted, enclosed and restrictive system may provide a moist underbelly for the vegetation bed in the top soil immediately above. This is aesthetically and functionally advantageous to users of the space above the system.

The permeable geofabric sheet layer constitutes part of the top cover. The geofabric sheet layer underlies the layer of crushed rock or clay and is positioned underneath the soil. This may have the effect of slowing down filtration into the system, more particularly the interstitial spaces amongst the substrate and coil stacks. This maintains moisture in the top soil.

The present inventive system is unlike prior art systems where water drains quickly into a reservoir. Prior art reservoirs are typically covered with an impermeable plastic layer (eg PVC) so as to grow plant life above, thus missing out on surface water collection and potentially creating drainage issues around their prior art systems. The prior art may provide a pervious lid for soak pits or detention systems, but these are not water holding systems for potable water as the top soil would simple dry out too quickly to support plant life.

The system is advantageous in that not only can it collect roof and surface water, but may have the added benefit of solving onsite drainage issues at ground level.

In another aspect of the invention, the system may provide a water drainage, filtration and storage system that has the same features as previously described, with the exception that it provides a hybrid lower-part storage and top part enhanced drainage portion. The hybrid system may include the stacks, the substrate, the impermeable and impervious layers, the sump and pump systems, and inflow and outflow pipes, as for the above described system.

However, in the hybrid system, the impervious sheet in the form of a dam liner, for example an impermeable plastics sheeting such as PVC liner, extends only partway up the side walls of the hole. The upper edge of the impermeable liner may terminate part way up the walls of the hole, for example, about half way up the walls of the hole. The permeable layer in the form of geofabric lines the internal side of the impermeable layer and continues to the top of the hole, for example to ground level. The overflow provides an outlet to deter the water level in the hole from going higher than the upper edge of the impermeable liner. The overflow is preferably at or around the same level as the impermeable liner upper edge. The overflow is therefore preferably located at a level equal to part way up the sump, preferably about half way up the sump, and in any case, immediately below the upper edge of the impermeable liner.

It will be appreciated that any of the features described herein can be used in any combination, and that the invention as described in respect of the second aspect may have the specific features referred to above in respect of the invention as described in respect of the first aspect.

### BRIEF DESCRIPTION OF THE DRAWINGS

The invention may be better understood from the following non-limiting description of preferred embodiments, in which:

FIG. 1A is a cross-section of a water holding system-;

FIG. 1B is a close-up cross-sectional view of multiple permeable, an impermeable and a spacer layer of the water holding system-;

FIG. 1C is a close-up cross-sectional view of a impermeable sandwiched between two permeable layers of the water holding system-;

FIG. 2 is a close-up cross-sectional view of a valve of the water holding system;

FIG. 3 is an under-side view of the valve of the water holding system;

FIG. 4 is a top side view of the valve of the water holding system;

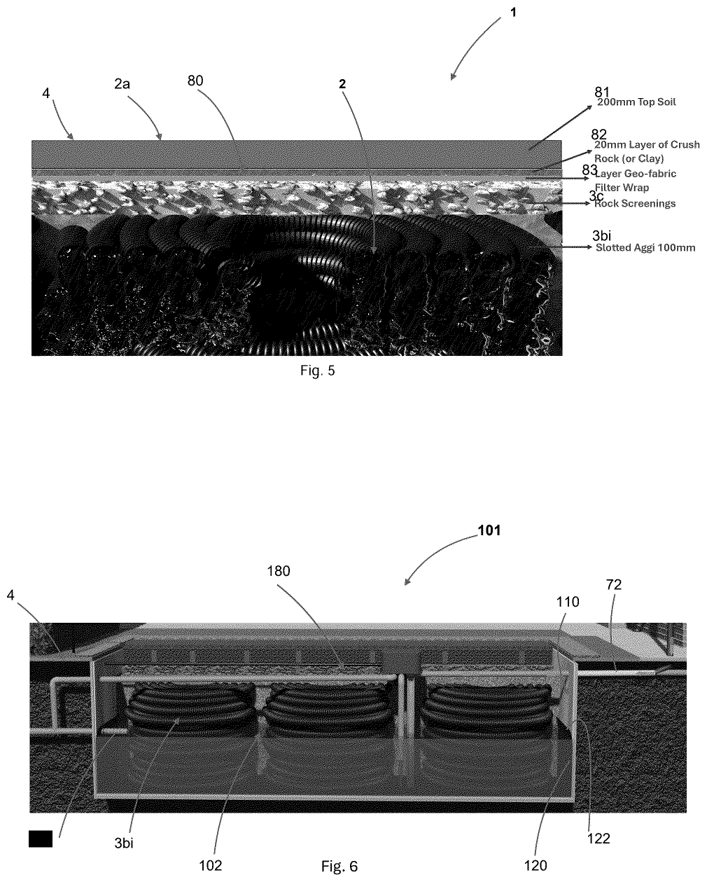

FIG. 5 is a schematic cross-sectional view of a water holding system according to a second embodiment; and

FIG. 6 is a schematic exposed view of a water holding tank according to a third embodiment.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. In describing the various embodiments of the invention, like features will be referred to using like references, with references for features of each embodiment generally preceded by 1, 2, 3, or followed by a Roman numeric sequence, such as i, ii, iii, etc. or an alphabetical sequence such as a, b, c, relative to the corresponding feature of the first embodiment. For example, a feature 10 of the first embodiment may represented as 110, 210, 310, (or n10), or 10a, 10b, 10c, (or 10x) or 10i, 10ii, 10iii, (or 10r) etc. in second, third and fourth embodiments, respectively.

Reference is made to Applicant's previous published patent application No. AU2021269296, the entire contents of which are hereby incorporated into the present specification.

A water holding system 1 including lining a hole 2 with both a permeable 10 and impermeable 20 to water layer in the form of a film or sheet, the impermeable layer 20 positioned exterior relative to the permeable layer 10. The hole 2 is filled with a water permeable filtration medium 3a, wherein the water holding system 1 includes a valve 30 positioned at a base 1a of the water holding system 1 and a first access pipe 40 including Agi pipe extending from the valve 30 to ground level 4.

### Water Holding System

The hole 2 may be an inground pool, pond or other hole.

The water permeable filtration medium includes coils of stacked agi pipes 3bi. It optionally includes cut lengths of agi pipes 3bii arranged between the coils of stacked agi pipes 3bi to further occupy interstitial cavities between the stacked columns 3bi. The water permeable filtration medium further includes a substrate 3c such as gravel, sand or other porous mediums is adapted to fill the hole 2 and spaces between the agi pipes 3bi,3bii. The water permeable filtration medium 3a is adapted to be situated on top of the permeable layer 10. The substrate 3c is adapted to fill the remaining available spaces in the hole 2 not excluded by Agi pipe, for example, up to a desired level below ground level 4.

The substrate 3c is adapted to filter out heavy particulates such as sticks, leaves, dirt, silt. The substrate 3c is adapted to drip or slow filter water. Furthermore, the substrate's 3c large cavities or the porous nature of the substrate 3c medium may allow for high volumes of water to be held in between substrate 3c particulates in the spaces outside the Agi pipe 3bi.

The substrate 3c is in the form of heavy particulates, such as screenings or rock, the particles having an average diameter of 10⁻²⁵ mm, a density of 1.3-1.7 T/m³, and a volume of around 1000-3000 mm³ (1-3×10⁻⁶ m³). The substrate 3c is sufficient to hold down the water holding system, preventing the water holding system from rising with any rise in ground water. The collective mass and distribution through the spaces of the heavy particulates of the substrate 3c is advantageously above a buoyancy force of the water holding system. Accordingly, the water holding system, particularly the water impermeable layer 20, and/or the concrete or plastic defining the hole 2, will not float or rise if the ground surrounding the water holding system 1 is water-logged or the water table level in the immediate vicinity and surrounds rises above the base 1a. The overall mass and distribution throughout the spaces of the heavy particulates of the substrate 3c is sufficient to overcome the buoyancy force of the water holding system 1 if the water holding system 1 is surrounded by a rising water table at a level above the base 1a.

### Permeable Layer

The permeable layer 10 is made from a synthetic wool in the form of a mat. The permeable layer is permeable to water but is adapted to be impermeable or to at least limit the passage through itself of silt, sand, gravel, and dirt. In other words, the permeable layer 10 acts as a first level filter or a filter sheet, the Agi pipe 3bi and substrate 3c performing subsequent filtration functions as the water moves from the top 2a of the hole 2 to the bottom 2b of the hole 2 or the base 1a.

The permeable layer 10 preferably lines the entire hole 2.

### Impermeable Layer

The impermeable layer 20 is a flexible sheet material. The impermeable layer 20 is made from materials such as a PVC sheet or other plastic sheets that are impermeable to water, silt, sand and gravel.

The impermeable layer 20 preferably lines the hole 2 at least up to a maximum internal water level. More preferably, the impermeable layer 20 lines the entire hole 2.

### Spacer Layer

The water holding system 1 further includes a spacer layer 50. The spacer layer 50 includes hollow and permeable plastic panels with spacer holes 52. The spacer layer 50 is ideally positioned between the impermeable layer 20 and the permeable layer 10. The spacer layer 50 is adapted to provide a debris-free zone from which water can be pumped to the ground surface 4 with a pump 54. The water holding system 1 includes a filtered water access pipe 44 adapted to house the pump 54 inline. The access pipe 44 is adapted to be located adjacent the first access pipe 42. The first and second access pipes 42,44 are adapted to be positioned vertically and to extend through the stacked agi pipes 3bi (stacked coil of agi pipes). The pump 54 is adapted to pump water from the base 1a of the water holding system 1 and out through a clean water pipe 55. Debris is filtered out through the substrate 3c and through the permeable layer 10 and filtered water is held in any cavities such as inside the agi pipes 3bi, 3bii and between the substrate particles 3c.

The spacer layer 50 creates a substrate free zone between the permeable layer 10 and the impermeable layer 20. The spacer layer 50 also provides a noise absorbing platform on which the pump 54 rests.

The spacer layer 50 is in the location of a sump at the base of first access pipe 42. The spacer layer 50 is located at the base 1a in the vicinity under the valve 30. The spacer layer 50 in this location provides a defined protected space for clean water to collect. It provides a defined volume from which clean water may be extracted with reduced flow resistance. There may be less strain on the pump 54 as an inline filter may not be necessary. Minimising loading on the pump 54 is useful to ameliorate the unavoidable loading of gravitational pull against upward extraction of clean water from the spacer layer 50 in the form of the sump or clean water reservoir.

The spacer layer 50 extends through the sump as a corridor. The corridor is about 500 mm wide and long, and is about 30 mm in height, thereby defining a void volume of about 0.0075 m³ (7500 cm³). The spacer layer 50 is positioned above the permeable layer 10 and below the coil stacks 3bi. This arrangement advantageously decreases the energy needed for pumping the water from the spacer layer 50 upward to deliver water to the access pipes 42,44.

The spacer layer 50 operates as a drainage cell, providing the void volume of around 0.005-0.01 m³ under the columns 3bi and particulate material 3c for water to collect in the effective sump defined by the spacer layer 50. The spacer layer 50 provides for multi directional flow of water. The flow rates achieved using a single access pipe may be consistent with the flow achieved by typical mains pressure in Australia (at least 100 kPa, typically 300-550 kPa, and ideally about 500 kPa).

The valve 30 may be positioned centrally on the base 1a of the water holding system 1 and may be accessible via the first access pipe 42. The valve 30 is a one-way valve adapted to automatically admit water under pressure and against the check valve's bias from exterior to the base 1a of the hole 2 through the impermeable layer 20 to inside hole 2 through the permeable layer 10. The valve 30 extends through the impermeable layer 20 as shown in FIG. 2. The valve 30 is adapted to release pressure build up underneath the impermeable layer 20. A manual rod 60 may be used to manipulate a cap of the valve 30 to unscrew the cap and permit repair or replacement.

The valve 30 is advantageously hydrostatic and is incorporated in the system 1 at the location of the sump (spacer layer 50), below the access pipe 42, and within the footprint of the spacer layer 50.

The water impermeable layer in the form of a plastic dam liner 20 is advantageously installed in the hole 2 to provide a water-tight seal. The hole 2 may be a reclaimed pool reservoir, from or for which the hole 2 was formed. The system 1 includes a the hydrostatic valve 30 installed in the water impermeable layer 20 to allow ground water to flow up into the sump to prevent the pool from popping out of the ground.

### Access Pipe

The first access pipe 42 is a pipe with holes through it. This can be, for example, in the form of agi pipe or or slotted PCV pipe, with Agi pipe being preferred inter alia to minimise the complexity of the system by having fewer different components or materials. The first and second access pipes 42,44 are adapted to be permeable to water.

The first access pipe 42 is orientated vertically. The first access pipe 42 is adapted to receive the rod or pole 60. The pole 60 is adapted to dislodge and/or release the cap, e.g. by rotating the valve 30 or unscrewing/screwing the valve 30 by means of a claw, hook, or pincer.

The first access pipe 42 is no larger than 150 mm in internal diameter. This is advantageous to limit the danger of small children or animals getting caught in this upper accessible part of the system 1.

### Inlet Valve

The water holding system 1 further includes an inlet valve 70. The inlet valve 70 includes a first filter to remove sticks, leaves, or other large debris. The inlet valve 70 is adapted to feed water directly into the substrate 3 through the impermeable layer 20. The inlet valve is adapted to receive stormwater from stormwater plumbing 72.

### Surface and Drainage

Referring particularly to FIGS. 1 and 5, the system 1 includes a permeable top cover 80 at and immediately below ground level 4. The cover 80 preferably extends across the entire expanse of the mouth 2a of the hole 2. The system 1 may therefore be effective to maintain lawn or garden soil 81 above the hole 2. The layer of soil 81 may extend to a depth from the ground surface 4 of between 100-500 mm, preferably 150-300 mm, most preferably about 200 mm, in a vertical direction.

The top cover 80 includes a permeable layer 82,83. This permeable layer may include a layer of crushed rock or clay 82, the crushed rock or clay layer 82 having a depth of between 10-50 mm, preferably 15-30 mm, most preferably about 20 mm, in the vertical direction. The crushed rock of layer 82 may comprise the same material as the substrate 3c, or may be finer in that the individual particles are smaller on average. The permeable layer acts as a filter for water draining from the top soil 81.

The permeable layer may further include a permeable sheet layer 83. The permeable sheet layer 83 is preferably in the form of a sheet of geofabric 12, although it could comprise synthetic unwoven mesh material, or natural fibre mesh materials including hessian or core fibre mesh. The permeable sheet layer 83 preferably extends across the entire mouth 2a, at its periphery preferably overlapping or abutting the permeable sheet layer 10 that, with the impermeable layer 20, lines the hole 2.

The system 1 provides a source of moisture to grow plants immediately above the system 1 in the top soil 81. The system 1 may support an enclosed plant and vegetation bed founded on and in the top soil 81. The support is structural to enable activities to go on at ground surface and above as if it is a normal patch of lawn with no cavity in the form of the hole 2 therebelow. The structural support comprises, in part, the slotted coil stacks 3bi and the rock screenings 3c. This compacted, enclosed and restrictive system 1 provides a moist underbelly for the vegetation bed in the top soil 81 immediately above. This is aesthetically and functionally advantageous to users of the space above the system 1.

The permeable geofabric sheet layer 83 constitutes part of the top cover 80. The geofabric sheet layer 83 underlies the layer of crushed rock or clay 82 and is positioned underneath the soil 81. This may have the effect of slowing down filtration into the system 1, more particularly the interstitial spaces amongst the substrate 3c and coil stacks 3bi. This maintains moisture in the top soil 81.

Immediately below the permeable layer 83, the substrate 3c in the form of rock screenings is used to fill the interstitial spaces between the coil stacks 3bi and in the internal cylindrical columns defined by the stacks 3bi. The coil stacks 3bi and substrate 3c are present throughout the hole 2 below the permeable layer 83 and above the base 1a.

In another embodiment of the invention shown in FIG. 6, there is provided a water drainage, filtration and storage system 101 that has the same features as system 1, with the exception that it provides a hybrid lower-part storage 102 and top part enhanced drainage portion 180.

The system 101 includes the stacks 3bi, the substrate 3c, the impermeable and impervious layers 10,20, the sump and pump systems and inflow and outflow pipes, as for system 1.

However, in the system 101, the impervious sheet 120 in the form of a dam liner, for example an impermeable plastics sheeting such as PVC liner, extends only partway up the side walls of the hole 102. The upper edge 122 of the impermeable liner 120 may terminate part way up the walls of the hole 102, for example, about half way up the walls of the hole 2. The permeable layer 10 in the form of geofabric lines the internal side of the impermeable layer 20 and continues to the top of the hole 2, for example to ground level 4. The overflow 115 provides an outlet to deter the water level in the hole from going higher than the upper edge 122 of the impermeable liner 120. The overflow 115 is therefore preferably located part way up the sump, preferably about half way up the sump. This is preferably at the same level as the impermeable liner upper edge 122.

### Definitions, Meanings, Qualifications and Explanations

Throughout the specification and claims the word “comprise” and its derivatives are intended to have an inclusive rather than exclusive meaning unless the contrary is expressly stated, or the context requires otherwise. That is, the word “comprise” and its derivatives will be taken to indicate the inclusion of not only the listed components, steps, or features that it directly references, but also other components, steps or features not specifically listed, unless the contrary is expressly stated, or the context requires otherwise.

“Agi pipe” is a corrugated drainage pipe made from plastic material that is typically used to drain ground water in domestic and agricultural applications, as well as construction and road projects. The light-weight corrugated pipe is typically cylindrical and flexible. It has regularly slotted openings along its length to allow drainage.

In the present specification, terms such as “apparatus”, “means”, “device” and “member” may refer to singular or plural items and are terms intended to refer to a set of properties, functions or characteristics performed by one or more items or components having one or more parts. It is envisaged that where an “apparatus”, “means”, “device” or “member” or similar term is described as being a unitary object, then a functionally equivalent object having multiple components is considered to fall within the scope of the term, and similarly, where an “apparatus”, “assembly”, “means”, “device” or “member” is described as having multiple components, a functionally equivalent but unitary object is also considered to fall within the scope of the term, unless the contrary is expressly stated or the context requires otherwise.

In the present specification, the phrase “and/or” refers to severally or any combination of the features. For example, the phrase “feature 1, feature 2 and/or feature 3” includes within its scope any one of the following combinations: Feature 1 or feature 2 or feature 3; feature 1 and feature 2 or feature 3; feature 1 or feature 2 and feature 3; feature 1 and feature 3 or feature 2; feature 1 and feature 2 and feature 3.

The meaning of descriptive, precise, or absolute terms such as “flexed”, “normal”, “parallel”, “horizontal”, “vertical” or “fully” includes the preceding qualifier “substantially or almost”, unless the context or contrary is expressly indicated, which may be taken to indicate a variation in an absolute value of between 0° and 10° or between 0% and 10%, relative to the absolute value of the term.

Qualifying relative terms, such as “relatively”, “sufficiently”, “near”, “almost” or “substantially”, may be taken to indicate a variation in an absolute value of between 0° and 10° or between 0% and 10%, relative to the absolute value. For example, “near horizontal” may be taken to mean any orientation between 0° and 10° relative to the horizontal.

If the word “for” is used to qualify a use or application of an object term, it is only limiting in the sense that the device or component should be “suitable for” that use or application.

In the present specification, the term “integral” means formed of one body in a single process.

In particular, the term “integrally formed” means formed of the one body without post-forming attachment of separately formed component parts. That is, “integrally formed” and the similar term “unitarily formed” mean formed in a single forming process and do not include post-forming attachment of component parts by means of fastener or other component fixing substances or methods.

Orientational terms used in the specification and claims such as vertical, horizontal, top, bottom, upper and lower are to be interpreted as relational and are based on the premise that the component, item, article, apparatus, device, or instrument will usually be considered in a particular orientation, for example with the coil stacks standing upright and the access pipes aligned substantially vertically.

In the present specification, the term “integral” means formed of one body in a single process. In particular, the term “integrally formed” means formed of the one body without post-forming attachment of separately formed component parts. That is, “integrally formed” and the similar term “unitarily formed” mean formed in a single forming process and do not include post-forming attachment of component parts by means of fastener or other component fixing substances or methods.

The articles “a” and “an” are used herein to refer to one or to more than one (i.e. to at least one) of the grammatical object of the article. By way of example, “an element” means one element or more than one element.

It will be appreciated by those skilled in the art that many modifications and variations may be made to the methods of the invention described herein without departing from the spirit and scope of the invention. The features and components of each of the embodiments of the invention described in the detailed description and/or depicted in the accompanying drawings may be interchangeable as required, with regard to functional equivalency and compatibility. A feature or component described with reference to one but not all embodiments, if functionally and dimensionally compatible as an addition with another embodiment herein described, or substitutable with a corresponding feature or component of that other embodiment in relation to which it has not been expressly described, should be read as a potential addition or substitution to that other embodiment and as being within the scope of the invention. Furthermore, in considering a feature or component that is described in relation a particular embodiment but may be omitted from the embodiment without losing the functionality characterising the invention and without departing from the scope of the invention, unless the context and expressions used in describing the embodiment imputes that the feature or component is essential to the invention as broadly described, the omittable feature or component may be read as not being included in the embodiment.

The claims:

1. A water holding system for installation in a hole in the ground, the hole lined with both a water-permeable layer in the form of a flexible sheet and a water-impermeable layer in the form of a film or sheet, the impermeable layer positioned exterior relative to the permeable layer, a plurality of stacks of permeable plastic pipes, the spaces between the stacks being filled with a particulate filtration medium that allows water to flow between the particles, wherein:
at least one of the stacks is in the form of an access column that includes an access pipe that extends inside the access column's central corridor from a low level of the hole upwardly to the upper level of the hole;
the access pipe is no more than 200 mm in diameter at its upper access end to limit access and the system has a water pump connected at or near the base of the access pipe to pump filtered water from the low level;
at the base of the access column, extending parallel to the base of the hole or substantially horizontally in between the permeable layer and the impermeable layer, is a spacer layer structurally adapted to support the access column above the impermeable layer and to maintain a flow-facilitating space free of material of the particulate filtration medium under the permeable layer immediately under the access column; and
a valve positioned at or below the low level and above the first access pipe which is a laterally permeable pipe extending from the valve to the upper level.

2. The water holding system according to claim 1, wherein the access pipe is no larger than 150 mm in internal diameter.

3. The water holding system according to claim 1, wherein the access pipe is in the form of an agi pipe.

4. The water holding system according to claim 1, wherein the spacer layer creates a medium-free zone between the permeable layer and the impermeable layer.

5. The water holding system according to claim 4, wherein the spacer layer comprises at least one plastic panel containing cavities that create the medium-free zone.

6. The water holding system according to claim 1, wherein the stacks include layers of agi pipes.

7. The water holding system according to claim 1, wherein each of the stacks is in the form of a coil that forms a permeable vertical column in the shape of a thick-walled cylinder defining a central corridor inside each column.

8. The water holding system according to claim 1, wherein the access column includes a second pipe in the form of an inspection pipe.

9. The water holding system according to claim 8, wherein the second pipe is adjacent and parallel the first access pipe and has an internal diameter no more than 200 mm.

10. The water holding system according to claim 1, wherein the system supports a layer of top soil to maintain a lawn and or garden immediately there above.

11. The water holding system according to claim 10, wherein the system includes a permeable top layer immediately below the top soil.

12. The water holding system according to claim 11, wherein the top layer includes a layer of crushed rock or clay.

13. The water holding system according to claim 12, wherein the top layer includes a permeable layer of sheet material.

14. The water holding system according to claim 13, wherein the permeable layer of sheet material supports and is immediately below the crushed rock or clay whereby this does not penetrate the permeable layer of sheet material and remains thereabove.

15. The water holding system according to claim 14, wherein the impermeable layer extends only partway up the sides of the hole and the permeable layer extends the whole way up the sides of the hole.
